(19) United States
(12) Patent Application Publication
(10) Pub. No.: US 2013/0058436 A1
(43) Pub. Date: Mar. 7, 2013

(54) APPARATUS AND METHOD FOR PROCESSING A SIGNAL

(71) Applicants: SANG-WOO KIM, Hwaseong-si (KR); Yoon-Kyung Choi, Seoul (KR)

(72) Inventors: SANG-WOO KIM, Hwaseong-si (KR); Yoon-Kyung Choi, Seoul (KR)

(21) Appl. No.: 13/564,807

(22) Filed: Aug. 2, 2012

(30) Foreign Application Priority Data
Sep. 6, 2011 (KR) 10-2011-0090197

(51) Int. Cl. H04L 27/00

(52) U.S. Cl. 375/316

(57) ABSTRACT

A signal processing apparatus stores previously determined function values using parameters through a processing unit, and outputs the stored function data using subsequently input data as an address.

### CROSS-REFERENCE TO RELATED PATENT APPLICATION

This application claims the benefit of Korean Patent Application No. 10-2011-0090197, filed on Sep. 6, 2011, in the Korean Intellectual Property Office, the disclosure of which is herein incorporated by reference in its entirety.

### BACKGROUND

1. Technical Field

The present disclosure relates to an apparatus and method for processing a signal.

2. Discussion of Related Art

Signal processing is related to the operations on, or analysis of, signals including, for example, sound, images, time-varying measurement values and sensor data, control system signals, telecommunication transmission signals, etc. Accordingly, signal processing is used in a variety of electronic devices. For example, image signal processing may be implemented by a video apparatus for capturing an image and/or for displaying the captured image.

### SUMMARY

According to an exemplary embodiment of the present disclosure, a signal processing method includes receiving first data, extracting a first parameter from the first data, determining at least one first function value with respect to the first data based on the first parameter, storing the at least one first function value as at least one stored function value, receiving second data, and outputting a function value selected from the at least one stored function value as output data by using the second data as an address for retrieving the function value from the at least one stored function value.

According to an exemplary embodiment of the present disclosure, a signal processing method includes receiving first data, extracting a first parameter from the first data, determining at least one first function value with respect to the first data based on the first parameter, storing the at least one first function value as at least one stored function value, receiving second data, extracting a second parameter based on the second data upon determining that the second data is different than the first data, determining at least one second function value with respect to the second data based on the second parameter, updating the at least one stored function value with the at least one second function value, and outputting a first output function value selected from the at least one stored function value as output data by using the second data as an address for retrieving the first output function value from the at least one stored function value.

According to an exemplary embodiment of the present disclosure, a signal processing apparatus includes a control unit configured to determine N first function values with respect to N data values of first input data based on a first parameter of the first input data, wherein N is a natural number, and a function value storage unit configured to store the N first function values, and output a function value selected from the N first function values as output data according to a data value of second input data.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a signal processing apparatus according to an exemplary embodiment of the inventive concept;

FIG. 2 is a block diagram of an image signal processing apparatus including the signal processing apparatus of FIG. 1;

FIG. 3 is a timing diagram for explaining an operation of the image signal processing apparatus of FIG. 2;

FIG. 4 is a block diagram of a signal processing apparatus according to an exemplary embodiment of the inventive concept;

FIG. 5 is a block diagram of a signal processing apparatus according to an exemplary embodiment of the inventive concept;

FIG. 6 is a block diagram of a signal processing apparatus according to an exemplary embodiment of the inventive concept;

FIG. 7 is a block diagram of a signal processing apparatus according to an exemplary embodiment of the inventive concept;

FIG. 8 is a block diagram of an example of a micro control unit (MCU) of FIG. 1;

FIG. 9 is a block diagram for explaining signal processing performed by the signal processing apparatus of FIG. 1;

FIG. 10 is a block diagram of a signal processing apparatus according to an exemplary embodiment of the inventive concept;

FIG. 11 is a block diagram of an image signal processing apparatus including the signal processing apparatus of FIG. 8;

FIG. 12 is a block diagram of a signal processing apparatus according to an exemplary embodiment of the inventive concept;

FIG. 13 is a block diagram of a signal processing apparatus according to an exemplary embodiment of the inventive concept;

FIG. 14 is a block diagram of a signal processing apparatus according to an exemplary embodiment of the inventive concept;

FIG. 15 is a block diagram of a signal processing apparatus according to an exemplary embodiment of the inventive concept;

FIG. 16 is a block diagram of a signal processing apparatus according to an exemplary embodiment of the inventive concept;

FIG. 17 is a block diagram of a signal processing apparatus according to an exemplary embodiment of the inventive concept;

FIG. 18 is a flowchart of a signal processing method, according to an exemplary embodiment of the inventive concept;

FIG. 19 is a flowchart of a signal processing method, according to an exemplary embodiment of the inventive concept;

FIG. 20 is a block diagram of a display apparatus according to an exemplary embodiment of the inventive concept; and

FIG. 21 is a block diagram of an example of an interface used in a system according to an exemplary embodiment of the inventive concept.

### DETAILED DESCRIPTION OF EXEMPLARY EMBODIMENTS

Exemplary embodiments of the inventive concept will now be described more fully with reference to the accompanying drawings. The inventive concept may, however, be embodied in many different forms and should not be construed as being limited to any embodiment determined forth herein; rather, embodiments are provided so that this disclosure will be thorough and complete, and will fully convey the concept of the invention to those of ordinary skill in the art.

As used herein, the term “and/or” includes any and all combinations of one or more of the associated listed items. Expressions such as “at least one of,” when preceding a list of elements, modify the entire list of elements and do not modify the individual elements of the list.

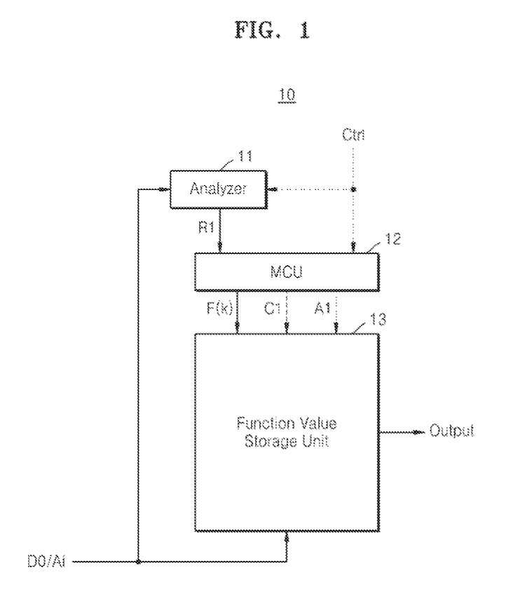

FIG. 1 is a block diagram of a signal processing apparatus 10 according to an exemplary embodiment of the inventive concept.

Referring to FIG. 1, the signal processing apparatus 10 includes an analyzer 11, a micro control unit (MCU) 12, and a function value storage unit 13. The function value storage unit 13 may be embodied in various types of memory including DRAM, SRAM, etc.

Input data D0/Ai is a digital value and may be a value determined in a predetermined range. Thus, if a video signal is provided to the signal processing apparatus 10, the video signal includes a plurality of pixel data, and the input data D0/Ai may be the pixel data. The input data D0/Ai may be expressed as a gradation value with respect to resolution. For example, if the input data D0/Ai is a 8 bit video signal, the input data D0/Ai may be expressed in a range of 0˜255, if the input data D0/Ai is a 9 bit video signal, the input data D0/Ai may be expressed in a range of 0˜511, and if the input data D0/Ai is a 10 bit video signal, the input data D0/Ai may be expressed in a range of 0˜1023. The video signal may include RGB (red, green, blue) color components.

In a case where data or a parameter of the input data D0/Ai changes from a previous value, the input data D0/Ai may be used as an address for outputting a function value.

More particularly, the analyzer 11 analyzes the input data D0/Ai and produces an analysis result R1. The analysis result R1 may include results such as an average value, variance, standard deviation, and a histogram analysis of the input data D0/Ai of the video signal. The analysis result R1 produced by the analyzer 11 is provided to the MCU 12. The analyzer 11 may periodically operate. For example, a period may be one frame of video data if the input data D0/Ai is the video signal. In addition to the periodic operation, the analyzer 11 may perform an analysis operation on the basis of an external control when the input data D0/Ai changes. The analyzer 11 may not perform the analysis operation if the input data D0/Ai does not change. For example, if the video signal is a still image signal and the input data D0/Ai does not change, the analyzer 11 may not perform the analysis operation.

The MCU 12 may perform a control operation for itself, or may be controlled according to a control signal Ctrl. The control signal Ctrl may be an external control signal. The MCU 12 may include one or more parameter extraction blocks. The MCU 12 determines parameters of the input data D0/Ai using the analysis result R1 received from the analyzer 11. The MCU 12 may update the determined parameters if the parameters of change. For example, the parameter may have a value relating to luminance if the input data D0/Ai is the video signal. Thus, the MCU 12 may determine whether luminance of the input data D0/Ai changes compared to luminance of a previous signal.

The function value storage unit 13 may store a result determined using a parameter with respect to each corresponding range of the input data D0/Ai. For example, a function value F(k) may be an arithmetic operation result obtained by performing an arithmetic operation (e.g., addition, subtraction, multiplication, division, etc.) on the input data D0/Ai and the parameter according to a predetermined function equation, and the function value F(k) may be stored in the function value storage unit 13. The function value F(k) may be selected by the function value storage unit 13 according to the input data D0/Ai. The selected function value F(k) may be output from the function value storage unit 13 as output data Output.

As a result, the function value storage unit 13 may store the function value F(k) with respect to all received input data D0/Ai through a corresponding function, and output the selected function value F(k) as the output data Output by using the input data D0/Ai as an address. Thus, a time for signal processing of the input data D0/Ai may be reduced.

The MCU 12 may update a parameter if the input data D0/Ai changes based on the analysis result R1, determine a function value according to the updated parameter, and update the function value stored by the function value storage unit 13.

As described above, the MCU 12 may periodically check the parameter through its own counter or initiate an update operation through the analysis result R1 of the analyzer 11 that periodically operates. In addition, the MCU 12 may initiate the update operation according to the control signal Ctrl. If the input data D0/Ai is the video signal, the control signal Ctrl may include information indicating whether the video signal is a still image signal or a moving image, and may be also provided to the analyzer 11.

Furthermore, the parameter and the function to which the parameter is applied may change according to the control signal Ctrl. Thus, the MCU 12 determines the parameter through a corresponding parameter extraction block from among the plurality of parameter extraction blocks, and determines a corresponding function value using the parameter. The determined function value F(k) may be stored in a corresponding cell of the function value storage unit 13 by using a corresponding input signal D0/Ai as an address. The MCU 12 may use an address A1 and a corresponding command C1 when the function value F(k) is stored in the function value storage unit 13.

The determination of the parameter and the function value of the MCU 12 may be provided in software, hardware, or firmware, and accordingly may be controlled and modified.

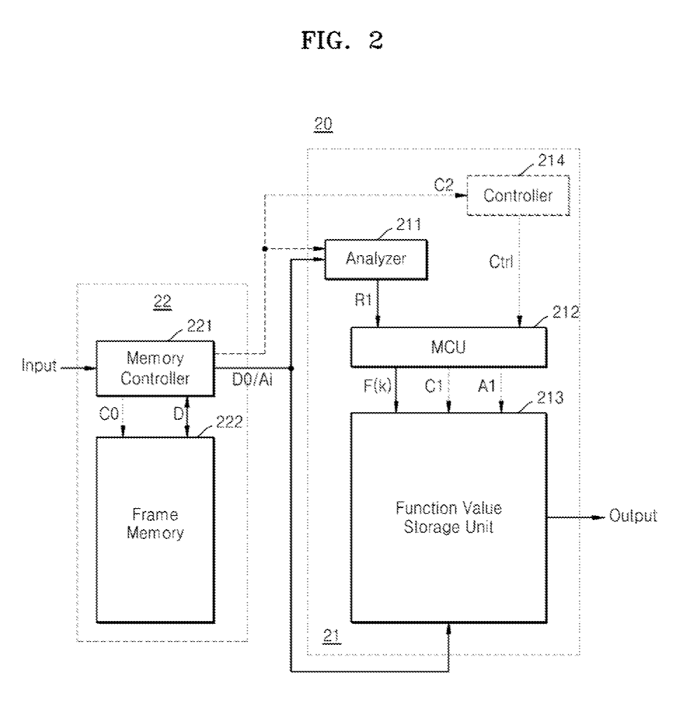

FIG. 2 is a block diagram of an image signal processing apparatus 20 including a signal processing apparatus 21 of FIG. 1.

Referring to FIG. 2, the image signal processing apparatus 20 includes the signal processing apparatus 21 and a graphics memory 22. The graphics memory 22 includes a memory controller 221 and a memory 222. An input signal Input may be a video signal. The memory controller 221 controls reading and writing of the video signal D to and from the memory 222 through a command C0. The command C0 may include an address signal. The input signal Input may include a plurality of data. For example, if the input signal Input is a video signal in a frame unit, the input signal Input may include a plurality of pixel data included in a frame. The pixel data is sequentially provided to the signal processing apparatus 21 as the input data D0/Ai.

The memory 222, including a frame memory, responds to controls of the memory controller 221. Thus, if the input signal Input is the video signal in the frame unit, the input signal Input may be stored in the frame unit. The memory controller 221 may control an operation of the signal processing apparatus 21 through a control signal C2. The control signal C2 may include a clock signal Clock for synchronizing the graphics memory 22 and the signal processing apparatus 21. Although not shown, the graphics memory 22 and/or the signal processing apparatus 21 may further include a delay lock loop (DLL) or a phase locked loop (PLL) for compensating for a signal delay difference between an internal circuit and an interface.

The elements of the signal processing apparatus 21 of FIG. 2 are substantially the same as the signal processing apparatus 10 of FIG. 1 except for a controller 214, and thus a detailed description thereof will be omitted here.

The controller 214 receives the control signal C2 from the memory controller 221 and controls an MCU 212 according to the control signal Ctrl. The controller 214 may perform a control operation for itself, and may not perform the control operation if the controller 214 performs an interface function only.

In this regard, the control signal C2 may control an operation for updating a parameter if the parameter changes. Thus, the control signal C2 may be provided to each of the analyzer 211 and/or the MCU 212 through the controller 214 or directly.

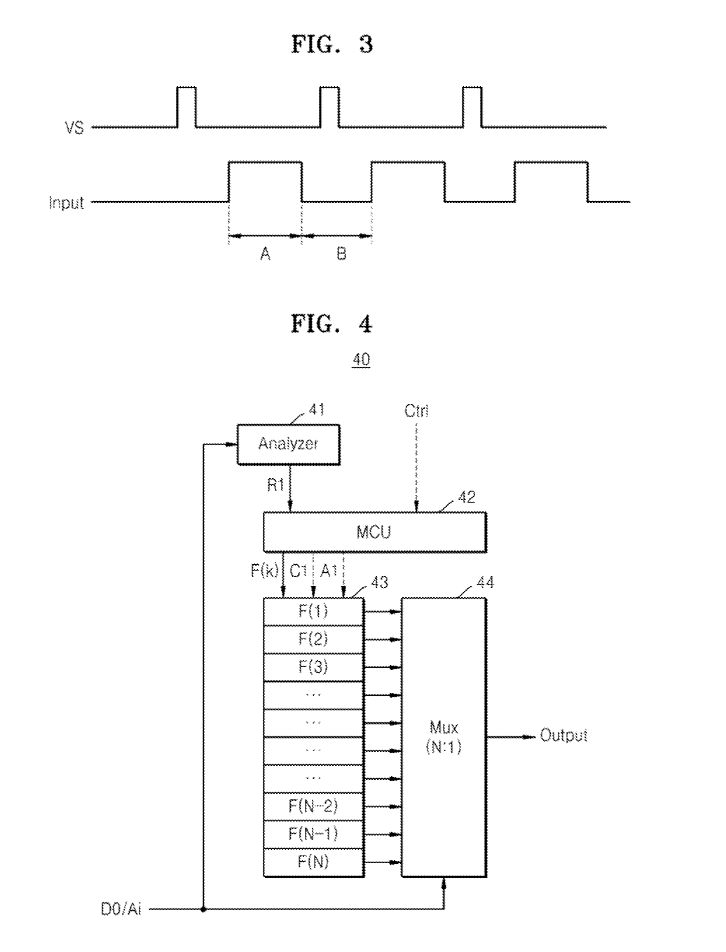

FIG. 3 is a timing diagram for explaining an exemplary operation of the image signal processing apparatus of FIG. 2 that is applied to display driving.

Referring to FIG. 3, the input signal Input is received according to a vertical synchronization signal VS. In this regard, image analysis is performed on the input signal Input during a section “A”. The image analysis may be regarded as being performed by the analyzer 211 of FIG. 2. An update operation of a parameter and a function value of the MCU 212 through an analysis result may be performed during a section “B” between an input of the input signal Input.

The section A for conducting the analysis on the input signal Input may be performed periodically and only when the input signal Input changes. The section B for conducting the update on the parameter and the function value may be performed according to the analysis result of the section A.

FIG. 4 is a block diagram of a signal processing apparatus 40 according to an exemplary embodiment of the inventive concept.

Referring to FIG. 4, the signal processing apparatus 40 includes an analyzer 41, an MCU 42, a look-up table (LUT) 43, and a selector 44. The constructions and operations of the analyzer 41 and the MCU 42 are substantially similar to those described with reference to FIGS. 1 and 2 and thus descriptions thereof will be omitted here.

The MCU 42 determines the function value F(k) using a parameter extracted through an analysis result of the input data D0/Ai and a previously determined function. In a case where the input data D0/Ai includes one data value from 1 to N, function values F(1)˜F(N) with respect to each data value of the input data D0/Ai may be stored in the LUT 43. The function value F(k) is stored in the LUT 43 wherein data values of the input data D0/Ai correspond to addresses of the LUT 43. The function value F(k) may be provided to the LUT 43 as write data and stored in the LUT 43 according to the command C1 and the address A1. The MCU 42 may update a parameter according to the analysis result R1 provided by the analyzer 41, determine the function value F(k) according to the updated parameter, and update the function value F(k) stored in the LUT 43.

The N function values F(1)˜F(N) (where N is a natural number) stored in the LUT 43 are provided to the selector 44. The selector 44 selects a function value F(k) corresponding to the address of the input data D0/Ai from the N function values F(1)˜F(N) by using the input data D0/Ai as an address, and outputs the selected function value as the output data Output. For example, if the input data D0/Ai is an 8 bit signal, the data value of the input data D0/Ai may be one of 1 to 256, and N has a value of up to 256. The selector 44 selects and outputs one of the N function values F(1)˜F(N) by using the input data D0/Ai as the address.

Although the input data D0/Ai is used as an address, the data value of the input data D0/Ai may be used as the address. As described herein, if the N function values F(1)˜F(N) are stored in random access memory (RAM), the input data D0/Ai may be used as an address. Alternatively, if the selector 44 is implemented as a circuit such as a multiplexer, the input data D0/Ai may be used as a control signal or a selection signal.

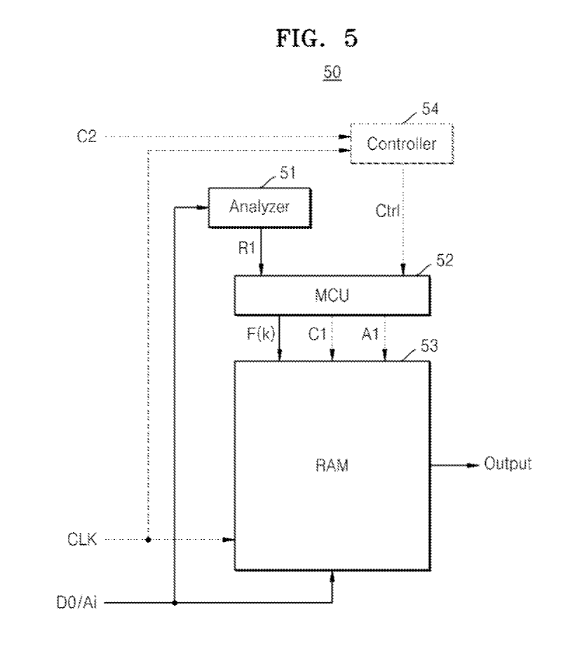

FIG. 5 is a block diagram of a signal processing apparatus 50 according to an exemplary embodiment of the inventive concept.

Referring to FIG. 5, the signal processing apparatus 50 includes an analyzer 51, an MCU 52, a RAM 53, and a controller 54. The constructions and operations of the analyzer 51, the MCU 52, and the controller 54 are substantially similar to those described with reference to FIG. 2 and thus descriptions thereof will be omitted here.

The MCU 52 determines the function value F(k) using a parameter extracted from the input data D0/Ai and a previously determined function. The function value F(k) is stored in the RAM 53 wherein the input data D0/Ai (or data values of the input data D0/Ai) correspond to addresses of the RAM 53. The function value F(k) may be provided to the RAM 53 as write data according to the command C1 and the address A1. The MCU 52 may update a parameter according to the analysis result R1 provided by the analyzer 51, determine the function value F(k) according to the updated parameter, and update the function value F(k) to the RAM 53.

The RAM 53 is a randomly accessible memory and selects a function value corresponding to the input data D0/Ai from among the N function values (where N is a natural number) as the output data Output by using the input data D0/Ai as an address. In this regard, the output data Output may be output in synchronization with the clock signal CLK, and may be synchronized through a strobe signal. The RAM 53 may include a dynamic random access memory (DRAM), a static RAM (SRAM), etc.

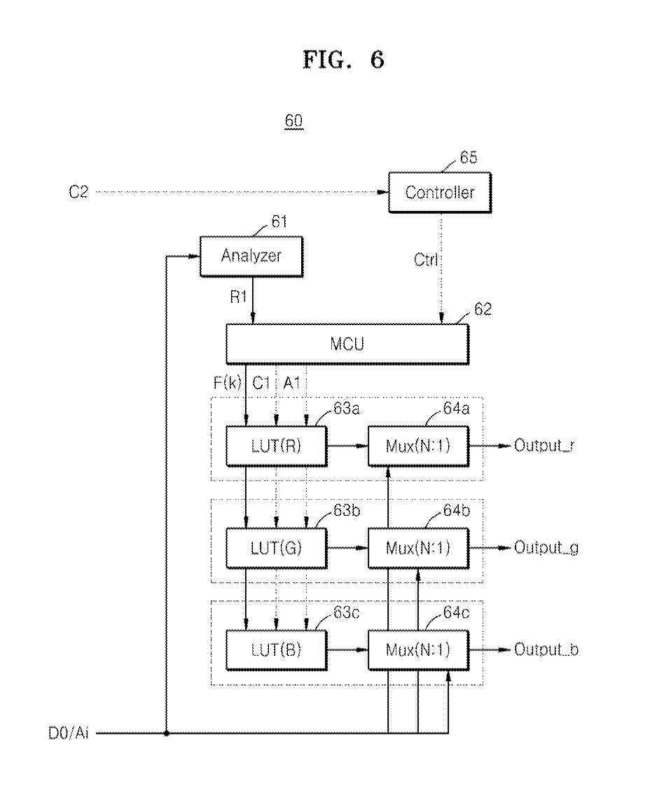

FIG. 6 is a block diagram of a signal processing apparatus 60 according to an exemplary embodiment of the inventive concept.

Referring to FIG. 6, the signal processing apparatus 60 includes an analyzer 61, an MCU 62, LUTs 63a through 63c, selectors 64a through 64c, and a controller 65. The constructions and operations of the analyzer 61, the MCU 62, and the controller 65 are substantially similar to those described with reference to FIG. 5 and thus descriptions thereof will be omitted here.

An input signal D0/Ai of FIG. 6 has three colors of red R, green G, and blue B, and a predetermined bit of data for each color, and thus constructions of an interface and an internal circuit may be changed accordingly. Although the input signal D0/Ai is described having the R, G, and B colors for purposes of explanation of FIG. 6, the input signal D0/Ai may further include complementary colors including are magenta Mg, cyan Cy, yellow Ye, white W, black B, etc.

The MCU 62 determines the function value F(k) corresponding to each of the R, G and B colors using a previously determined function and a parameter. Thereafter, the function value F(k) is stored in the LUTs 63a through 63c according to the address A1. The address A1 may correspond to a value of the input data D0/Ai. The function value F(k) may be provided to the LUTs 63a through 63c as write data and may be stored in the LUTs 63a through 63c according to the command C1 and the address A1. The MCU 62 may update the parameter according to the analysis result R1 provided by the analyzer 61, and update the function value F(k) according to the updated parameter in the LUTs 63a through 63c.

The selectors 64a through 64c select function values corresponding to addresses of the input data D0/Ai from the N function values (where N is a natural number) stored in the LUTs 63a through 63c as output data Output_r, Output_g, and Output_b by using the input data D0/ai as an address.

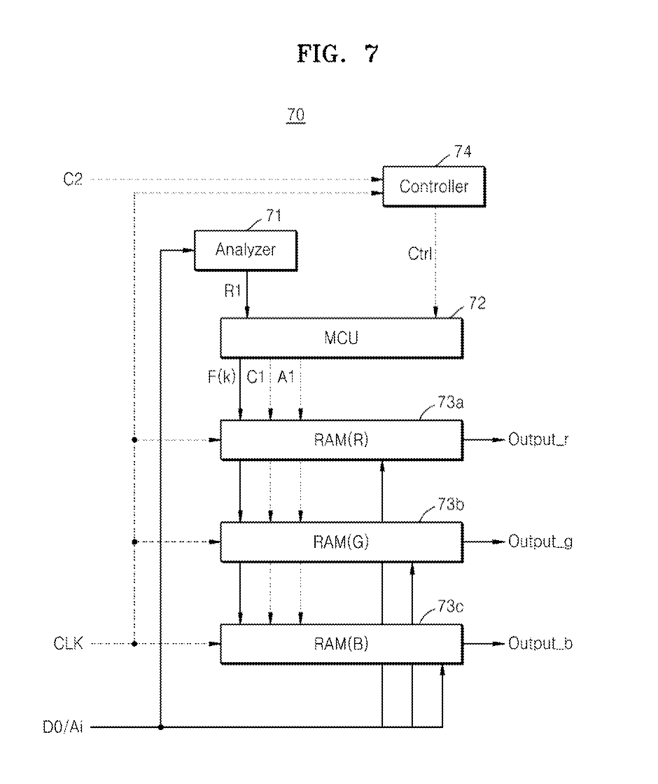

FIG. 7 is a block diagram of a signal processing apparatus 70 according to an exemplary embodiment of the inventive concept.

Referring to FIG. 7, the signal processing apparatus 70 includes an analyzer 71, an MCU 72, RAMs 73a through 73c, and a controller 74. The constructions and operations of the analyzer 71, the MCU 72, and the controller 74 are substantially similar to those described with reference to FIGS. 2 and 5 and thus descriptions thereof will be omitted here.

According to FIG. 7, the input data D0/Ai has three colors of R, G, and B each having a corresponding bit, and thus constructions of an interface and an internal circuit may be changed differently for each color.

The MCU 72 determines the function value F(k) corresponding to each of the R, G, and B colors using a previously determined function and a parameter. Thereafter, the function value F(k) is stored in the RAMs 73a through 73c according to the address A1. The address A1 may correspond to a value of the input data D0/Ai. The function value F(k) may be provided to the RAMs 73a through 73c as write data and may be stored in the RAMs 73a through 73c according to the command C1 and the address A1. The MCU 72 may update the parameter according to the analysis result R1 provided by the analyzer 71, and update the function value F(k) according to the updated parameter in the RAMs 73a through 73c.

The RAMs 73a through 73c are randomly accessible memories, and select and output the output data Output_r, Output_g, and Output_b corresponding to addresses of the input data D0/Ai from the N function values (where N is a natural number) by using the input data D0/ai as an address. In this regard, the output data Output_r, Output_g, and Output_b are synchronized with the clock signal CLK, and may be synchronized through a strobe signal. The RAMs 73a through 73c may include DRAMs, SRAMs, etc.

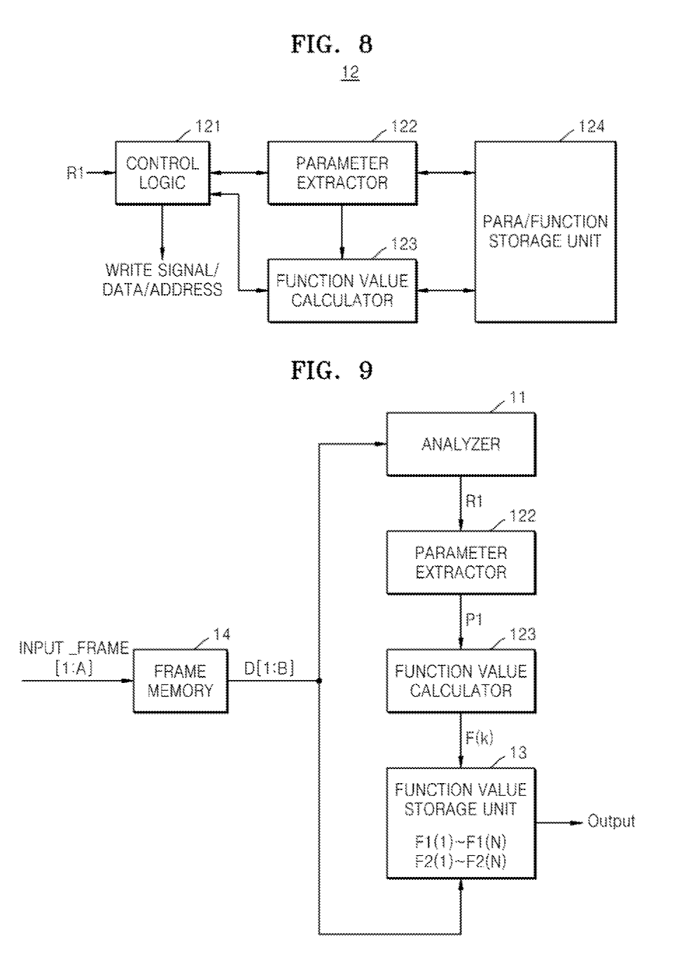

FIG. 8 is a block diagram showing an example of the MCU 12 of FIG. 1. The MCU 12 of FIG. 8 may be implemented in conjunction with the signal processing apparatus of FIG. 1 as well as to other embodiments in the same manner or in a similar manner.

Referring to FIG. 8, the MCU 12 may include a control logic 121, a parameter extractor 122, a function value calculator 123, and a parameter and function storage unit 124. The control logic 121 controls a general operation of the MCU 12. The control logic 121 may control an operation of the MCU 12 using the analysis result R1 provided by the analyzer 11 of FIG. 1.

The parameter extractor 122 extracts a parameter according to the analysis result R1. In the case of an input signal including frame data, where data of a current frame changes compared to data of a previous frame, the analysis result R1 may differ from an analysis result of the data of the previous frame. Thus, a new parameter is extracted according to the analysis result R1, and may be stored in the parameter and function storage unit 124.

The function value calculator 123 determines a function value using the extracted parameter and a predetermined function equation. For example, if input data includes values between 1 and N, the function value calculator 123 may determine the function value for each of the values of the input data. The control logic 121 may control an operation of storing the determined function value in the function value storage unit 13 of FIG. 1, and thus providing the function value storage unit 13 with a record command, record data, an address, etc. The write data corresponds to the function value determined by the function value calculator 123.

The parameter and function storage unit 124 may store information relating to the extracted parameter and the function equation. The function equation may be stored in another memory (not shown) included in the signal processing apparatus 10 of FIG. 1, and may be loaded in the parameter and function storage unit 124 when the signal processing apparatus 10 operates.

In a case where the MCU 12 is used, the function equation may be updated. For example, a plurality of function equations may be stored in an external storage unit (not shown), and at least one of the function equations may be loaded in the parameter and function storage unit 124. The function equation used for an operation may be selected by a user or according to the analysis result R1 of the input data. For example, luminance of an image frame may be determined by analyzing the input data. Different operations may be performed on the input data according to the analysis result R1.

FIG. 9 is a block diagram for explaining signal processing performed by the signal processing apparatus of FIG. 1. The signal processing of FIG. 9 may be implemented by the signal processing apparatus of FIG. 1 as well as to other embodiments in the same manner or in a similar manner.

In the case of an input signal including a frame, a plurality of frame signals Input_frame[1:A] are sequentially input. The frame signals Input_frame[1:A] are stored in the frame memory 14 as input signals.

Each of the frame signals Input_frame[1:A] includes a plurality of data (for example, pixel data). The pixel data is sequentially provided to the analyzer 11 and the function value storage unit 13 as input data D[1:B]. For example, one frame includes B number of pixel data, and the B number of pixel data may be sequentially provided one by one.

The analyzer 11 provides the parameter extractor 122 with the analysis result R1 of the input data D[1:B]. The analyzer 11 may sequentially perform an analysis operation on the input data D[1:B] one by one. The parameter extractor 122 generates a parameter using the analysis result R1 and provides the function value calculator 123 with the parameter. The function value calculator 123 determines the function value F(k) and provides the function value storage unit 13 with the function value F(k) as write data. The parameter and the function value F(k) may be extracted or determined using the analysis result R1 of the input data D[1:B] of one frame.

In addition, the function value storage unit 13 outputs one function value as the output data Output by using the input data D[1:B] as an address. For example, if each of the input data D[1:B] has a value between 1 and N, corresponding function values between F1(1) and F1(N) with respect to respective data values are stored in the function value storage unit 13.

When the output data Output for one frame is output, an update operation on the parameter and the function value may be performed. Function values F2(1) through F2(N) that are changed by using the above method are updated in the function value storage unit 13. Signal processing on a next frame is performed using the changed function values F2(1) through F2(N).

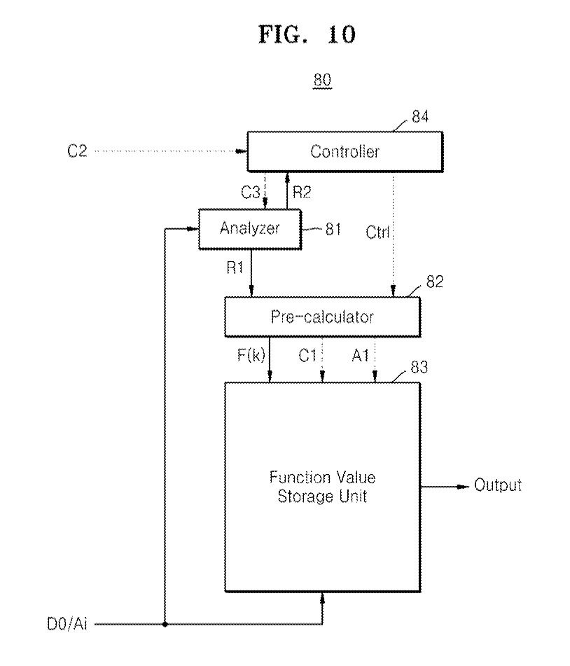

FIG. 10 is a block diagram of a signal processing apparatus 80 according to an exemplary embodiment of the inventive concept.

Referring to FIG. 10, the signal processing apparatus 80 includes an analyzer 81, a controller 84, a pre-calculator 82, and a function value storage unit 83. The constructions and operations of the analyzer 81 and the controller 84 are substantially similar to those described with reference to FIGS. 2, 5, and 7 and thus descriptions thereof will be omitted here.

The analyzer 81 analyzes the input data D0/Ai and produces the analysis result R1. The analysis result R1 produced by the analyzer 81 may be provided to the pre-calculator 82. The analyzer 81 may periodically operate in a frame unit if, for example, the input data D0/Ai is a video signal. The analyzer 81 may not perform an analysis operation if the input data D0/ai includes a still image having little change. The analyzer 81 may perform the analysis operation if the input data D0/Ai includes a moving image that changes, providing the pre-calculator 82 with the analysis result R1.

The controller 84 receives the control signal C2 from the outside and controls the pre-calculator 82 according to the control signal Ctrl. The controller 84 may perform a control operation using an analysis result R2 of the analyzer 81. Although the analysis result R1 provided to the pre-calculator 82 and the analysis result R2 provided to the controller 84 are separated from each other, the analysis results R1 and R2 may be the same. The controller 84 may perform a control operation for itself, and may omit the control operation if the controller 84 performs only an interface function. The control signal C2 may include information used to control the analysis operation of the analyzer 81 described above.

The pre-calculator 82 may operate in response to the control signal Ctrl, determine a parameter based on the analysis result R1, and determine whether the parameter changes. If the parameter changes, the pre-calculator 82 determines the function value F(k) using the changed parameter, and updates a result to the function value storage unit 83.

If, for example, the input data D0/Ai is a video signal, the parameter may include information relating to luminance of the input data D0/Ai. Thus, the pre-calculator 82 may determine whether the luminance of the input data D0/Ai changes compared to luminance of a previous signal.

The function value storage unit 83 may store a result determined through the parameter with respect to each corresponding range of the input data D0/Ai. Thus, the corresponding function value F(k) may be selected and output according to the input data D0/Ai.

As a result, the function value storage unit 83 may previously store the function value F(k) with respect to the whole available input data D0/Ai through a corresponding function as an operation result, and output the corresponding function value F(k) by using the input data D0/Ai as an address. Thus, a time for signal processing may be reduced according to the input data D0/Ai.

The pre-calculator 82 may periodically check the analysis result R1 provided by the analyzer 81 according to the control signal Ctrl provided from the controller 84. Alternatively, as described above, the operation of the analyzer 81 may be controlled by a control signal C3 based on the external control signal C2, and the pre-calculator 82 may manually operate and determine the function value F(k) through the updated analysis result R1 of the analyzer 81.

The function value F(k) determined by the pre-calculator 82 may be stored in a corresponding cell of the function value storage unit 83 that uses each of the input data D0/Ai as an address. The pre-calculator 82 may use the address A1 and the corresponding command C1 when storing the function value F(k) in the function value storage unit 83. The MCUs described with reference to FIGS. 1 through 7 use a variable function in software or firmware, whereas the pre-calculator 82 uses one invariable parameter in hardware.

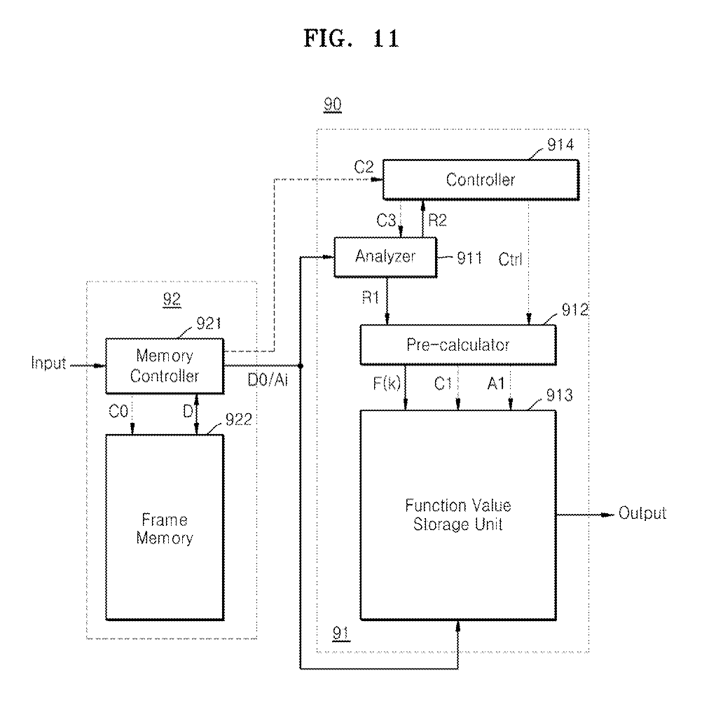

FIG. 11 is a block diagram of an image signal processing apparatus 90 including a signal processing apparatus 91 of FIG. 8.

Referring to FIG. 11, the image signal processing apparatus 90 includes the signal processing apparatus 91 and a graphics memory 92. The graphics memory 92 includes a memory controller 921 and a memory 922.

The input signal Input includes the video signal D. The memory controller 921 may control reading and writing of the video signal D from and to the memory 922 according to the command C0. The command C0 may include an address signal.

The memory 922 responds to control of the memory controller 921 and includes a frame memory. Thus, if the input signal Input is the video signal in a frame unit, the memory 922 may store the corresponding input signal Input in the frame unit. The memory controller 921 may control an operation of the signal processing apparatus 91 according to the control signal C2. The control signal C2 may include the clock signal Clock for synchronizing the graphics memory 92 and the signal processing apparatus 91. The graphics memory 92 and/or the signal processing apparatus 91 may further include a DLL or a PLL for compensating for a signal delay difference between an internal circuit and an interface.

The elements of the signal processing apparatus 91 of FIG. 11 are substantially the same as the signal processing apparatus 80 of FIG. 10, and thus a detailed description thereof will be omitted here.

The controller 914 receives the control signal C2 from the memory controller 921 and controls a pre-calculator 912 according to the control signal Ctrl. The controller 914 controls an analyzer 911 according to the control signal C3, and receives the analysis result R2 by the analyzer 911. The controller 914 may output the control signal Ctrl based on the control signal C2 and control the pre-calculator 912 according to the control signal Ctrl. The controller 914 may perform a control operation for itself, and may omit the control operation if the controller 914 performs an interface function only.

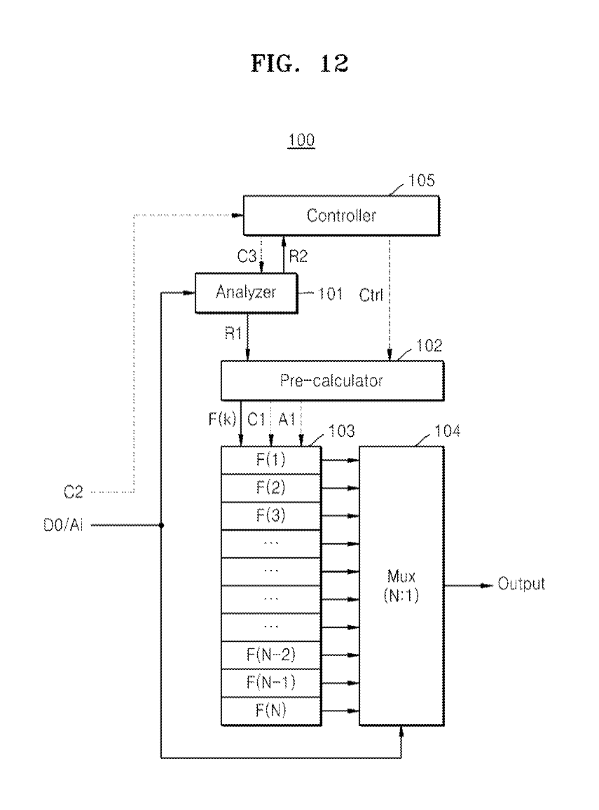

FIG. 12 is a block diagram of a signal processing apparatus 100 according to an exemplary embodiment of the inventive concept.

Referring to FIG. 12, the signal processing apparatus 100 includes an analyzer 101, a controller 105, a pre-calculator 102, an LUT 103, and a selector 104. The constructions and operations of the analyzer 101, the pre-calculator 102, and the controller 105 are substantially similar to those described with reference to FIGS. 10 and 11 and thus descriptions thereof will be omitted here.

The pre-calculator 102 determines the function value F(k) using a previously determined function and a parameter, and stores the determined function value F(k) in addresses corresponding to value of the input data D0/Ai of the LUT 103. The function value F(k) may be stored in the LUT 103 according to the command C1, for example, a write command, and the address A1. The pre-calculator 102 may update the function value F(k) stored in the LUT 103 by using an updated parameter according to the analysis result R1.

The selector 104 selects a function value corresponding to the address of the input data D0/Ai from the N function values F(1)˜F(N) (where N is a natural number) by using the input data D0/Ai as an address, and outputs the selected function value as the output data Output.

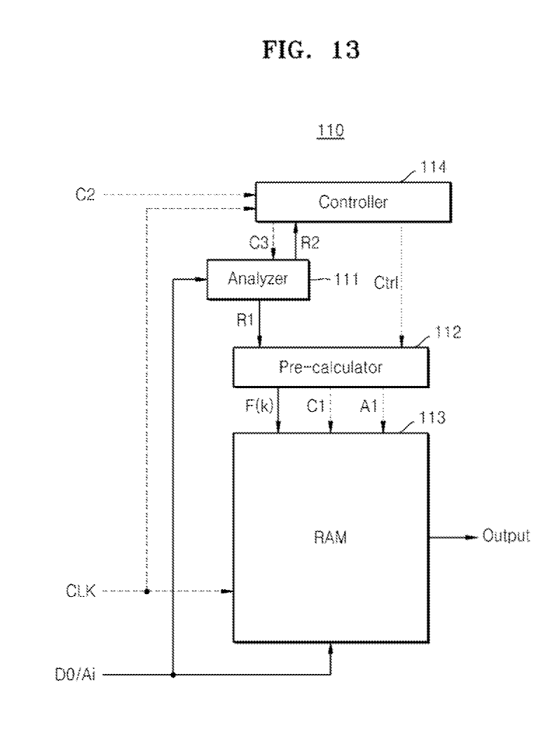

FIG. 13 is a block diagram of a signal processing apparatus 110 according to an exemplary embodiment of the inventive concept.

Referring to FIG. 13, the signal processing apparatus 110 includes an analyzer 111, a pre-calculator 112, a RAM 113, and a controller 114. The constructions and operations of the analyzer 111, the pre-calculator 112, and the controller 114 are substantially similar to those described with reference to FIGS. 10 and 12 and thus descriptions thereof will be omitted here.

The pre-calculator 112 determines the function value F(k) using a previously determined function and a parameter, and stores the function value F(k) in the RAM 113 wherein values of the input data D0/Ai correspond to addresses of the RAM 113. The function value F(k) may be stored (or written) in the RAM 113 according to the command C1 and the address A1. The pre-calculator 112 may update the function value F(k) stored in the RAM 113 according to the analysis result R1.

The RAM 13 is a randomly accessible memory and selects and outputs a function value corresponding to the address of the input data D0/Ai from among the N function values (where N is a natural number) as the output data Output by using the input data D0/Ai as an address. In this regard, the output data Output may be output in synchronization with the clock signal CLK, and may be synchronized through a strobe signal.

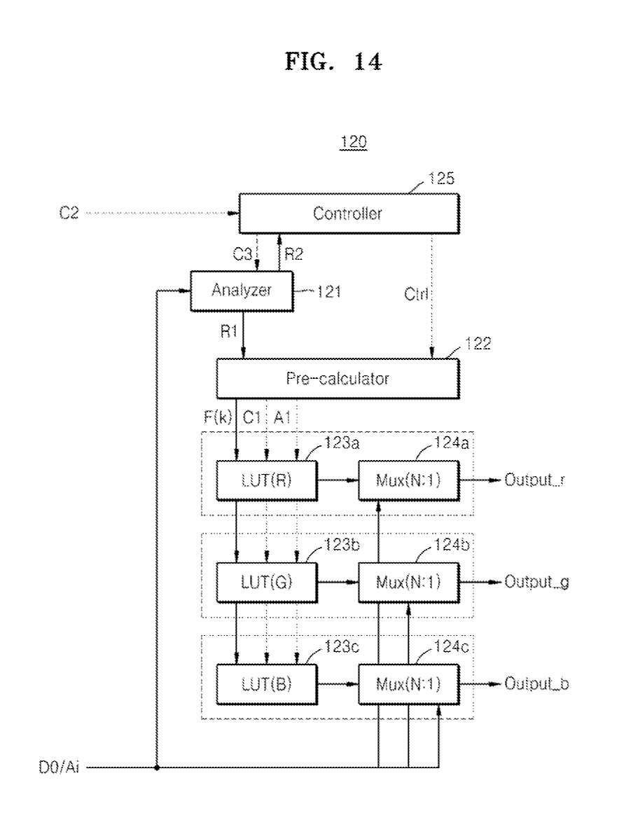

FIG. 14 is a block diagram of a signal processing apparatus 120 according to an exemplary embodiment of the inventive concept.

Referring to FIG. 14, the signal processing apparatus 120 includes an analyzer 121, a pre-calculator 122, LUTs 123a through 123c, selectors 124a through 124c, and a controller 125. The constructions and operations of the analyzer 121, the pre-calculator 122, and the controller 125 are substantially similar to those described with reference to FIGS. 10 through 13 and thus descriptions thereof will be omitted here. However, the input data D0/Ai has three colors of R, and B each having a corresponding data (or bit), and thus constructions of an interface and an internal circuit may be changed accordingly. While the input signal D0/Ai is described as including the R, G, and B colors, the input data D0/Ai may further include complementary colors that are magenta Mg, cyan Cy, yellow Ye, white W, black B, etc.

The pre-calculator 122 determine the function value F(k) corresponding to each of the R, G and B colors using a previously determined function and a parameter. Thereafter, the function value F(k) is stored in the LUTs 123a through 123c. The function value F(k) is stored in the address A1 corresponding to a value of the input data D0/Ai. The function value F(k) may be stored in the LUTs 123a through 123c according to the command C1 and the address A1. The pre-calculator 122 may update the function value F(k) stored in the LUTs 123a through 123c according to the analysis result R1.

The selectors 124a through 124c select function values corresponding to addresses of the input data D0/Ai from the N function values (where N is a natural number) as output data Output_r, Output_g, and Output_b by using the input data D0/ai as an address.

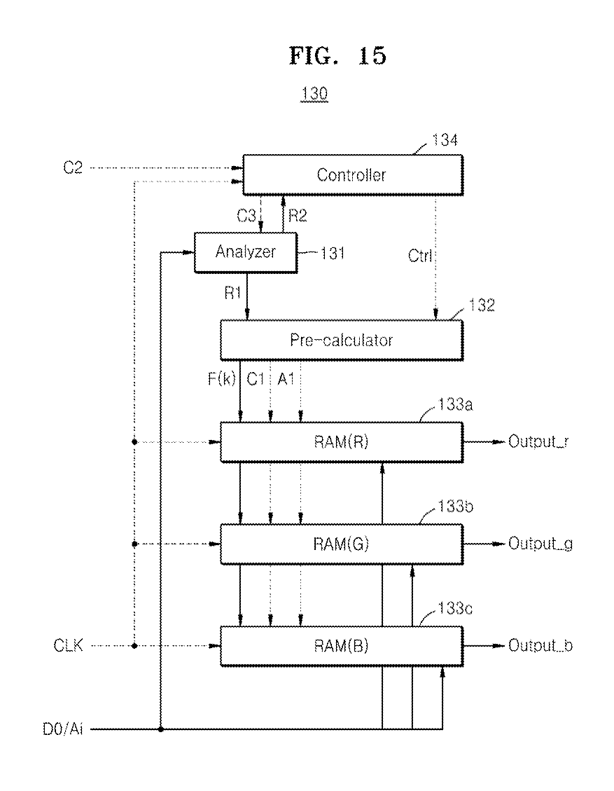

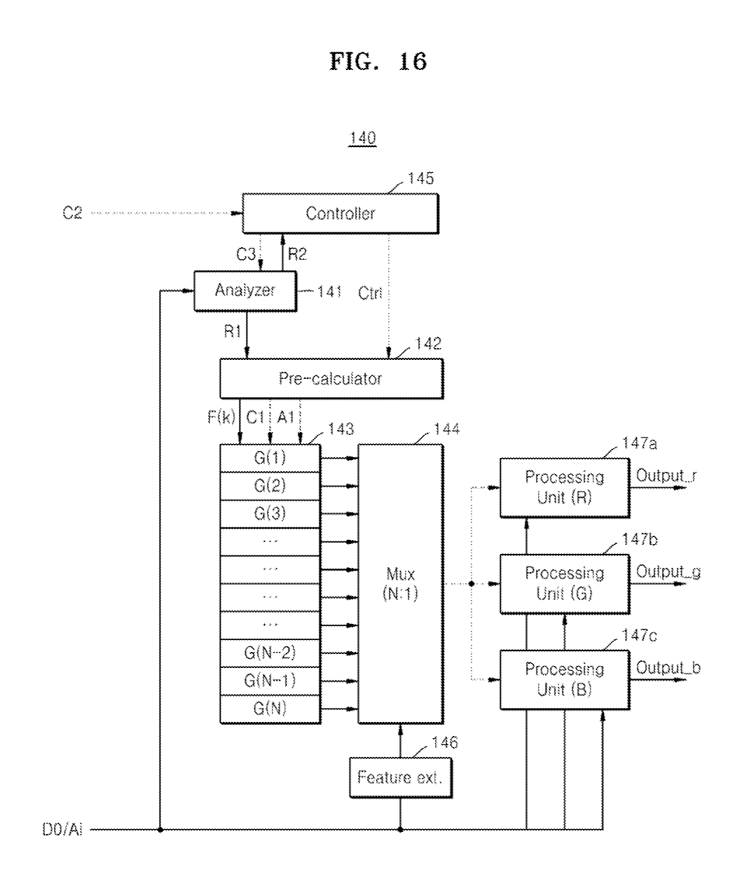

FIG. 15 is a block diagram of a signal processing apparatus 130 according to an exemplary embodiment of the inventive concept.

Referring to FIG. 15, the signal processing apparatus 130 includes an analyzer 131, a pre-calculator 132, RAMs 133a through 133c, and a controller 134. The constructions and operations of the analyzer 131, the pre-calculator 132, and the controller 134 are substantially similar to those described with reference to FIGS. 10 through 14 and thus descriptions thereof will be omitted here.

The input data D0/Ai has three colors of R, G, and B each having corresponding data (or bit), and thus constructions of an interface and an internal circuit may be changed accordingly.

The pre-calculator 132 determines the function value F(k) using a previously determined function and a parameter. Thereafter, the function value F(k) is stored in the RAMs 133a through 133c at the address A1 corresponding to a value of the input data D0/Ai. The address A1 may correspond to a value of the input data D0/Ai. The function value F(k) may be stored in the RAMs 133a through 133c according to the command C1 and the address A1. The pre-calculator 132 may update the function value F(k) stored in the RAMs 133a through 133c according to the analysis result R1.

The RAMs 133a through 133c are randomly accessible memories, and select and output function values corresponding to addresses of the input data D0/Ai from the N function values (where N is a natural number) as the output data Output_r, Output_g, and Output_b for each color by using the input data D0/Ai as an address. In this regard, the output data Output_r, Output_g, and Output_b are synchronized with the clock signal CLK, and may be synchronized through a strobe signal.

FIG. 16 is a block diagram of a signal processing apparatus 140 according to an exemplary embodiment of the inventive concept.

Referring to FIG. 16, the signal processing apparatus 140 further includes a representative value extractor 146 and color processing units 147A through 147c, in addition to the elements described with reference to FIG. 12. A function value determined using a separate parameter for each color is output in FIG. 14, whereas one LUT 143 is commonly used for three colors in FIG. 16. In addition, one selector 144 is commonly used for three colors.

The representative value extractor 146 extracts a representative value from the input data D0/Ai. In this regard, a certain value such as a maximum value or an average value may be extracted from each of R, G, and B pixels and determined as the representative value. The LUT 143 may store information used for signal processing other than a determined function value. For example, a pre-calculator 142 may determine and store a gain value G(k) in the LUT 143. The gain value G(k) may be determined for each of data values 1 through N of the input data D0/Ai. The determined gain values G(1) through G(N) may be stored in the LUT 143 by using the input data D0/Ai as an address.

A selection operation of the gain value G(k) is performed according to the input data D0/Ai. For example, the selector 144 may select and output one of the gain values G(1) through G(N) stored in the LUT 143 according to the representative value extracted from the input data D0/Ai. The output gain value is provided to the color processing units 147A through 147c. The color processing units 147A through 147c processor the gain value G(k) and the input data D0/Ai and output color output data Output_r, Output_g, and Output_b. The color processing units 147A through 147c do not perform all operation processes for data processing but may perform an operation using the gain value G(k), and thus a time for data processing may be reduced.

In FIG. 16, one LUT 143, other than LUTs for the R, G, and B colors, may be used, thereby reducing a load in terms of hardware. In this regard, one common parameter may be applied using the representative value in a corresponding pixel without using parameters for the R, and B colors.

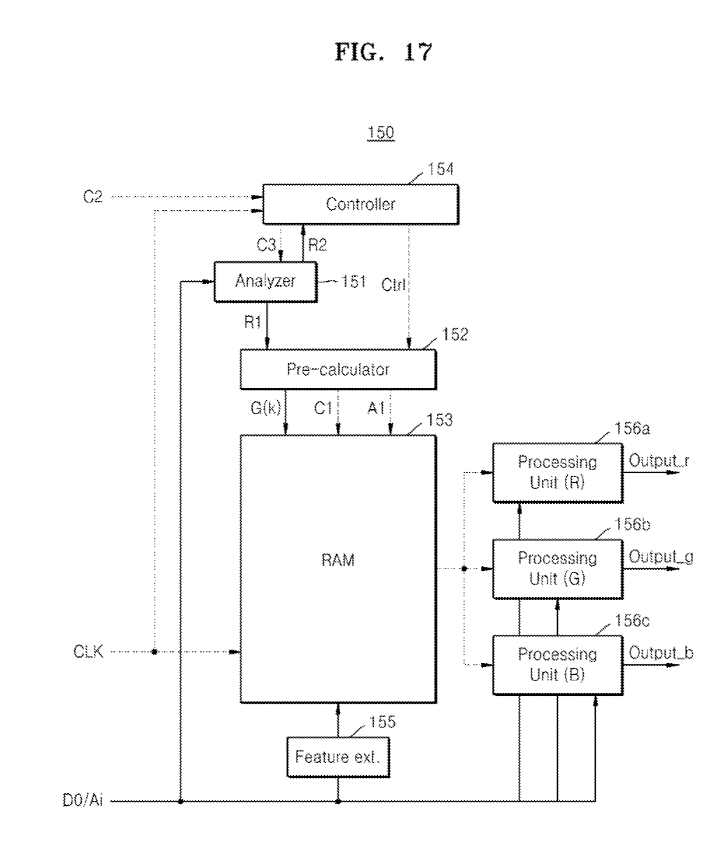

FIG. 17 is a block diagram of a signal processing apparatus 150 according to an exemplary embodiment of the inventive concept.

Referring to FIG. 17, the signal processing apparatus 150 further includes a representative value extractor 155 and color processing units 156a through 156c, in addition to the elements described with reference to FIG. 13. A function value determined using a separate parameter for each color is output in FIG. 15, whereas one RAM 153 may be commonly used for three colors in FIG. 17.

The representative value extractor 155 extracts a representative value from the input data D0/Ai. In this regard, a certain value such as a maximum value or an average value may be extracted from each of R, G, and B pixels and determined as the representative value. The RAM 153 does not store a determined function value but stores information used for signal processing, for example, a gain value. In this regard, the gain value is stored by using the input data D0/Ai or the representative value thereof as an address.

An output of the representative value extractor 155 may be an address for designating the gain value stored in the RAM 153. For example, the gain value of the RAM 153 corresponding to the representative value output from the representative value extractor 155 is selected. The selected gain value is provided to the color processing units 156a through 156c. The color processing units 156a through 156c process the gain value and the input data D0/Ai and output the color output data Output_r, Output_g, and Output_b.

In FIG. 17 one common parameter may be applied using the representative value in a corresponding pixel without using parameters for the R, G, and B colors.

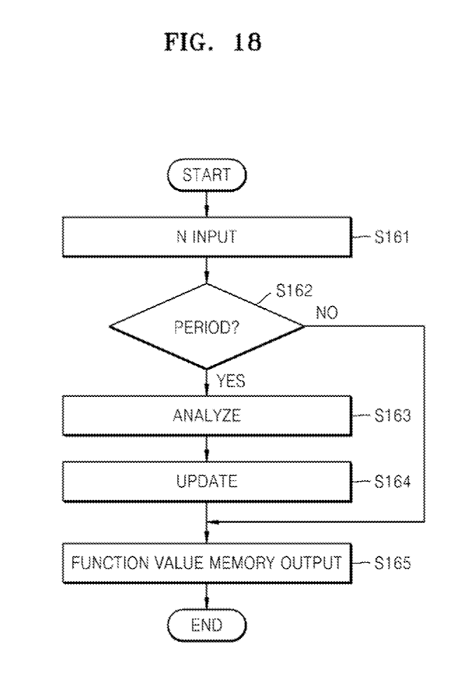

FIG. 18 is a flowchart of a signal processing method, according to an exemplary embodiment of the inventive concept.

Referring to FIG. 18, Nth data is input (operation S161). For example, the Nth data may include Nth frame data. A signal processing apparatus updates a value stored in a function value storage unit at a certain period. Such an update may be controlled by a MCU. The MCU determines a time for updating the function value storage unit (operation S162). If the MCU determines that the time is not an update period, a function value stored in the function value storage unit is output by using a corresponding value of input data in operation S165 as an address. The function value storage unit stores the function value according to a corresponding address by using the input data as the address.

If the MCU determines that the time is the update period in operation S162, the input data is analyzed by an analyzer (operation S163). The function value is determined using an analysis result, and the determined function value is updated to the function value storage unit (operation S164). If such an update is competed, the updated function value stored in the function value storage unit is output by using the corresponding value of the input data as the address.

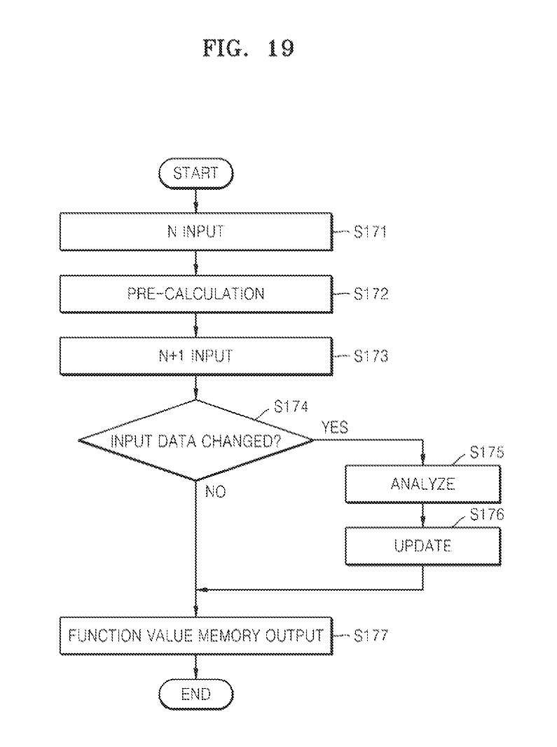

FIG. 19 is a flowchart of a signal processing method, according to an exemplary embodiment of the inventive concept.

Referring to FIG. 19, Nth data is input (operation S171). For example, the Nth data may include Nth frame data. In addition, the Nth data may be initial data for pre-determination. In this regard, the Nth data may be regarded as data for pre-determination. A signal processing apparatus determines a corresponding function value using the Nth data and stores the function value in a function value storage unit (operation S172). Thereafter, N+1th data is input (operation S173). The signal processing apparatus determines whether input data changes (operation S174). That is, the signal processing apparatus determines whether a parameter extracted by inputting the Nth data and a parameter extracted by inputting the N+1th data change (e.g., in relation to a threshold for variation). In this regard, if the input data is an image signal, for example, the parameters may have values relating to luminance of an image or other components.

If the signal processing apparatus determines that the input data changes (e.g., in relation to the threshold), the N+1th data is analyzed (operation S175), the function value is determined according to an analysis result, and updates the function value to the function value storage unit (operation S176).

If the signal processing apparatus determines that the parameters do not change (e.g., in relation to the threshold), the function value is not updated, a value stored in the function value storage unit is output by using the N+1th data as an address, and, if the function value is updated, the updated function value is output (operation S177).

The signal processing apparatus may determine whether an input signal changes through an external control signal in advance and omit an analysis operation. That is, if the signal processing apparatus determines that the input signal does not change, since a parameter does not change, the signal processing apparatus may output the function value corresponding to the input data without performing the analysis operation. If the signal processing apparatus determines that the input signal changes, the signal processing apparatus extracts a value of the changed parameter through the analysis operation, determines the function value, and updates the function value to the function value storage unit.

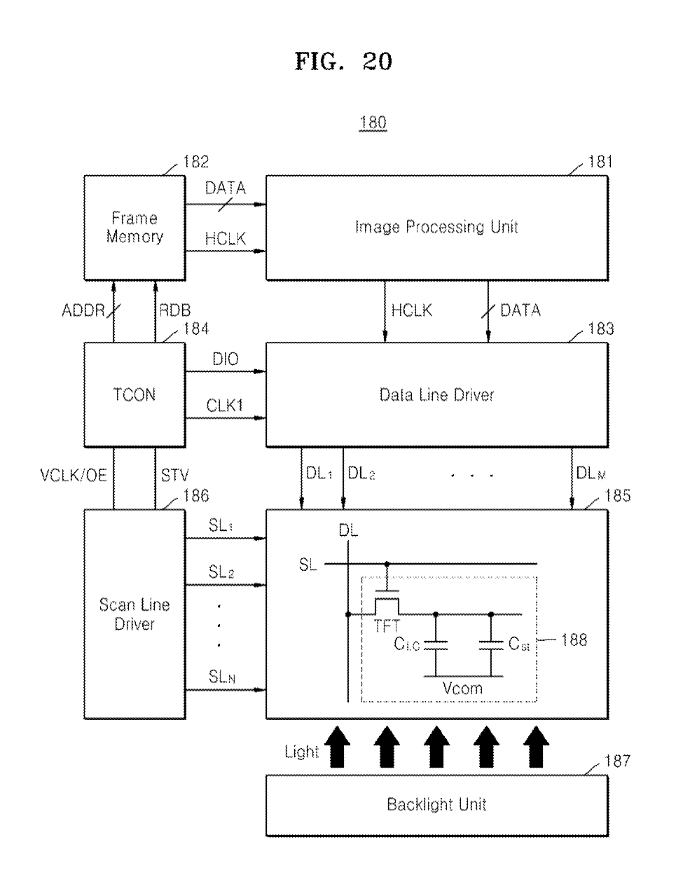

FIG. 20 is a block diagram of a display apparatus 180 according to an exemplary embodiment of the inventive concept.

Referring to FIG. 20, the display apparatus 180 according to an exemplary embodiment includes a panel 185, a data line driver 183, a scan line driver 186, a timing controller (TCON) 184, a LED backlight unit 187, a frame memory 182, and an image processing unit 181.

The frame memory 182 and the image processing unit 181 may include the constructions of the embodiments described with reference to FIGS. 1 through 17. That is, the frame memory 182 and the image processing unit 181 may determine a function value in advance, store the function value in a function value storage unit, and output a corresponding function value by using input data as an address.

The timing controller 184 may receive data input from an external graphics controller (not shown), including image data, a control signal, for example, vertical and horizontal synchronization signals, a main clock, a data enable signal, etc. The timing controller 184 may process the image data in accordance with an operation condition of a liquid crystal panel 185, generate a control signal for the scan line driver 186 and a control signal for the data line driver 183, and transmit the control signal for the scan line driver 186 and the control signal for the data line driver 183 to the scan line driver 186 and the data line driver 183, respectively. In this regard, the control signal for the scan line driver 186 may include a vertical start signal STV for outputting a gate voltage and an output enable signal OE controlling an activation section of the gate voltage. The control signal for the data line driver 183 may include a horizontal start signal DIO for transmitting the image data DATA and an output control signal CLK1 applying an analog gradation signal to a corresponding data line DL.

The frame memory 182 receives a data read command RDB and an address ADDR from the timing controller 184. The frame memory 182 receives a horizontal synchronization signal HCLK and the image dada DATA from the external graphics controller (not shown), and provides the image processing unit 181 with the horizontal synchronization signal HCLK and the image dada DATA.

The image processing unit 181 has substantially the same construction as the signal processing apparatuses described with reference to FIGS. 1 through 17. Thus, the image processing unit 181 provides the data line driver 183 with a value stored in the function value storage unit as output data by using the image data DATA provided from the frame memory 182 as an address. In addition, the image processing unit 181 may include an analyzer (not shown) to update the value stored in the function value storage unit according to a change in a parameter.

The data line driver 183 may include a plurality of data driver ICs (not shown). The scan line driver 186 may include a plurality of scan driver ICs (not shown). The display apparatus 180 may adjust transmittance of light and displays an image. The display apparatus 180 may use a separate light source. The display apparatus 180 may include the LED backlight unit 187 as the light source. Thus, the display apparatus 180 may display the image by allowing light of the LED backlight unit 187 that is disposed in the rear side of the panel 185 to be incident on the panel 185, and, if the panel 185 is a liquid crystal panel, adjusting an amount of transmitted light according to an arrangement of liquid crystals.

The panel 185 that is regarded as the liquid crystal panel will now be described below.

The liquid crystal panel 185 may include a plurality of scan lines SL₁ through SL_{N} extending in a first direction, a plurality of data lines DL₁ through DL_{N} extending in a direction orthogonal to the first direction in which the scan lines SL₁ through SL_{N} extend, and a pixel region 188 disposed in a region in which the scan lines SL₁ through SL_{N} and the data lines DL₁ through DL_{N} cross each other. The pixel region 188 includes a unit pixel including a thin film transistor TFT, a liquid crystal capacitor C_{LC}, and a storage capacitor Cst. Accordingly, the thin film transistor TFT may be turned on and off according to a driving signal applied to the scan lines SL₁ through SL_{N}, supply an analog gradation signal supplied through the data lines DL₁ through DL_{N} to a pixel electrode, and change electric fields of both ends of the liquid crystal capacitor C_{LC}. Thus, transmittance of the light supplied from the LED backlight unit 187 may be adjusted by changing the arrangement of liquid crystals (not shown).

A driving voltage generating unit (not shown) may generate various driving voltages for driving the liquid crystal panel 185 by using an external power source input from an external power source apparatus. The driving voltage generating unit may receive a first power source from the outside, and generate a second power source provided to the data line driver 183, a gate turn-on voltage and a gate turn-off voltage provided to the scan line driver 186, and a common voltage Vcom provided to the liquid crystal panel 185.

The scan line driver 186 may apply gate on/off voltages of the driving voltage generating unit (not shown) to the scan lines SL₁ through SL_{N} in response to the vertical start signal STV, a vertical synchronization signal VCLK, and the output enable signal OE provided from the timing controller 184. Accordingly, the thin film transistor TFT may be turned on wherein the analog gradation voltage output from the data line driver 183 is applied to a corresponding pixel.

The data line driver 183 may generate an analog gradation signal corresponding to digital image data in response to the control signal for the data line driver 183 from the timing controller 184 and apply the analog gradation signal to the data lines DL₁ through DL_{N} of the liquid crystal panel 185.

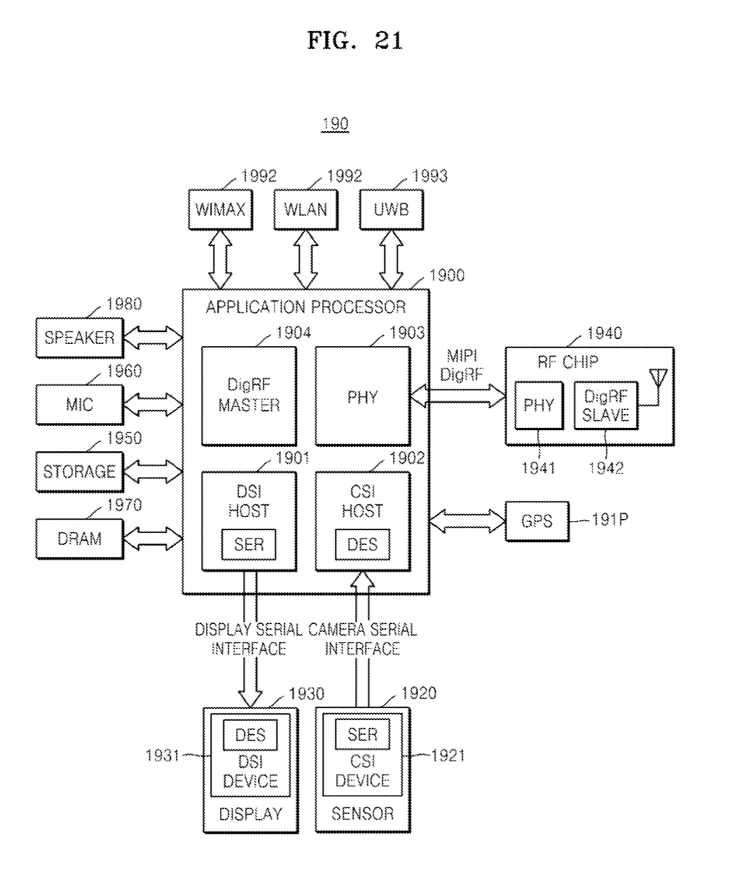

FIG. 21 is a block diagram of an exemplary interface used in a system 190 according to an exemplary embodiment of the inventive concept.

Referring to FIG. 21, the system 190 may be implemented as a data processing apparatus capable of using or assisting a mobile industry processor interface (MIPI), and may include an application processor (AP) 1900, an image sensor 1920, and a display 1930. A camera serial interface (CSI) host 1902 of the AP 1900 may perform serial communication with a CSI device 1921 of the image sensor 1920 through a CSI. The CSI host 1902 may include a deserializer (DES), and the CSI device 1921 may include a serializer (SER). The display 1930 may include the construction described with reference to FIG. 12.

A display serial interface (DSI) host 1901 of the AP 1900 may perform serial communication with a DSI device 1931 of the display 1930 through a DSI. The DSI host 1901 may include a serializer (SER), and the DSI device 1931 may include a deserializer (DES). The system 190 may further include a radio frequency (RF) chip 1940 communicating with the AP 1900. A physical layer interface (PHY) 1903 of the AP 1900 and a PHY 1941 of the RF chip 1940 may transmit and receive data each other according to the MIPI DigRF specification for wireless mobile radio frequency integrated circuit (RFIC) to base-band IC (BBIC) interfaces in mobile devices. The AP 1900 may further include a DigRF master 1904 controlling transmission and reception of data according to the MIPI DigRF.

The system 190 may include a global positioning system (GPS) 1910, a storage 1950, a microphone (MIC) 1960, a DRAM 1970, a speaker 1980. The system 190 may also perform communication using an ultra wideband (UWB) 1993, a wireless local area network (WLAN) 1992, and a worldwide interoperability for microwave access (WIMAX) 1991. However, the structure and interface of the system 190 are merely exemplary, and the inventive concept is not limited thereto.

While exemplary embodiments of the inventive concept have been particularly shown and described with reference to the drawings, it will be understood that various changes in form and details may be made therein without departing from the spirit and scope of the following claims.

What is claimed is:

1. A signal processing method comprising:
receiving first data;
extracting a first parameter from the first data;
determining at least one first function value with respect to the first data based on the first parameter;
storing the at least one first function value as at least one stored function value;
receiving second data; and
outputting a function value selected from the at least one stored function value as output data by using the second data as an address for retrieving the function value from the at least one stored function value.

2. The method of claim 1, wherein the first data and the second data comprise an image signal.

3. The method of claim 1, further comprising omitting an analysis of the second data upon determining that the second data is not different than the first data.

4. A signal processing method comprising:
receiving first data;
extracting a first parameter from the first data;
determining at least one first function value with respect to the first data based on the first parameter;
storing the at least one first function value as at least one stored function value;
receiving second data;
extracting a second parameter based on the second data upon determining that the second data is different than the first data;
determining at least one second function value with respect to the second data based on the second parameter;
updating the at least one stored function value with the at least one second function value; and
outputting a first output function value selected from the at least one stored function value as output data by using the second data as an address for retrieving the first output function value from the at least one stored function value.

5. The method of claim 4, further comprising;
receiving third data;
determining that the third data is not different than the second data; and
outputting a second output function value selected from the at least one stored function value as output data by using the third data as an address for retrieving the second output function value from the at least one stored function value.

6. The method of claim 4, further comprising:
determining that the second parameter is different from the first parameter upon detecting that the second data is different than the first data, prior to extracting the second parameter; and
initiating the extraction of the second parameter upon detecting that the second data is different than the first data.

7. The method of claim 4, wherein the first data and the second data comprise an image signal.

8. A signal processing apparatus comprising:
a control unit configured to determine N first function values with respect to N data values of first input data based on a first parameter of the first input data, wherein N is a natural number; and
a function value storage unit configured to store the N first function values, and output a function value selected from the N first function values as output data according to a data value of second input data.

9. The apparatus of claim 8, further comprising an analyzer configured to analyze the second input data and determining whether the first parameter changes on the basis of the second input data.

10. The apparatus of claim 9, wherein the first input data and the second input data are sequentially input,
wherein the analyzer is configured to compare the first input data with the second input data and initiate an extraction of a second parameter of the second input data upon determining that the second input data is different than the first input data.

11. The apparatus of claim 10, wherein the first data and the second data comprise an image signal.

12. The apparatus of claim 8, wherein the function value storage unit comprises:
a look up table (LUT) configured to store the N first function values; and
a selector configured to select one of the N first function values according to the data value of the second input data.

13. The apparatus of claim 8, wherein the function value storage unit comprises a random access memory (RAM) having N unit cells for storing the N first function values.

14. The apparatus of claim 8, wherein the control unit extracts a second parameter based on the second input data if the second input data is different than the first input data, and determines N second function values based on the second parameter,
wherein the N second function values are stored in the function value storage unit.

15. The apparatus of claim 8, wherein the first input data and the second input data are pixel data having data values between 1 and N, and the N first function values are determined by applying a function equation to each of the data values.

16. The apparatus of claim 8, wherein the N first function values are gain values of the first input data,
wherein the function value storage unit outputs one of the gain values by using the second input data as an address for retrieving the one of the gain values from the function value storage unit,
the apparatus further comprising: a processing unit for performing an operation on the one of the gain values and the second input data and outputting a result of the operation.
